(19) United States
(12) Patent Application Publication
(10) Pub. No.: US 2023/0300807 A1
(43) Pub. Date: Sep. 21, 2023

(54) METHODS AND APPARATUSES FOR TRANSMISSION USING PRECONFIGURED UPLINK RESOURCE

(71) Applicant: LENOVO (BEIJING) LIMITED, Beijing (CN)

(72) Inventors: Min XU, Beijing (CN); Lianhai WU, Beijing (CN); Jing HAN, Beijing (CN); Ran YUE, Beijing (CN); Haiming WANG, Beijing (CN); Jie SHI, Beijing (CN)

(21) Appl. No.: 18/041,737

(22) PCT Filed: Aug. 20, 2020
(86) PCT No.: PCT/CN2020/110283

§ 371 Date: Feb. 15, 2023

(51) Int. Cl. H04W 72/0446; H04W 56/00

(52) U.S. Cl. CPC H04W 72/0446; H04W 56/0045

(57) ABSTRACT

Methods for uplink transmission using a preconfigured uplink resource are provided. One embodiment of the subject application provides a method performed by a user equipment, including receiving a first preconfigured uplink resource configuration and one or more preconfigured uplink resource indications, and initiating an uplink transmission according to the first PUR configuration and the one or more PUR indications. Related apparatuses are also disclosed.

### TECHNICAL FIELD

Various example embodiments relate to methods and apparatuses for a transmission using a preconfigured uplink resource (PUR).

### BACKGROUND OF THE INVENTION

In 3GPP (3rd Generation Partnership Project), a transmission using a PUR is applicable to a bandwidth reduced low complexity (BL) user equipment (UE), a UE in an enhanced coverage, and a narrow band interne of things (NB-IoT) UE. It allows an uplink transmission from RRC_IDLE without performing a random access procedure.

The transmission using the PUR is enabled by a base station (BS) if a UE and the BS support the PUR. The UE may request to be configured with a PUR or to have a PUR configuration released while in RRC_CONNECTED mode. The BS may decide to configure a PUR based on a request from the UE, subscription information of the UE, and/or a local policy. The PUR is only valid in the cell where the UE receives the PUR configuration.

### SUMMARY

One embodiment of the subject application provides a method performed by a UE for transmission using a PUR, including receiving a first PUR configuration and one or more PUR indications, and initiating an uplink transmission according to the first PUR configuration and the one or more PUR indications.

Another embodiment of the subject application provides a method performed by a BS for transmission using a PUR, including transmitting, to a UE, a first PUR configuration and one or more PUR indications, for an uplink transmission initiated by the UE.

A further embodiment of the subject application provides an apparatus, which indicates a non-transitory computer-readable medium having stored thereon computer-executable instructions, a receiving circuitry, a transmitting circuitry, and a processor coupled to the non-transitory computer-readable medium, the receiving circuitry and the transmitting circuitry, wherein the computer-executable instructions cause the processor to implement a method performed by a UE. The method includes receiving a first PUR configuration and one or more PUR indications, and initiating an uplink transmission according to the first PUR configuration and the one or more PUR indications.

Another further embodiment of the subject application provides an apparatus, which indicates a non-transitory computer-readable medium having stored thereon computer-executable instructions, a receiving circuitry, a transmitting circuitry, and a processor coupled to the non-transitory computer-readable medium, the receiving circuitry and the transmitting circuitry, wherein the computer-executable instructions cause the processor to implement a method performed by a BS. The method includes transmitting, to a UE, a first PUR configuration and one or more PUR indications, for an uplink transmission initiated by the UE.

### BRIEF DESCRIPTION OF THE DRAWINGS

Some example embodiments will now be described, by way of non-limiting examples, with reference to the accompanying drawings.

FIG. 1 illustrates an example of a release of a PUR configuration.

FIG. 2 illustrates an example of a restriction of a PUR configuration.

FIG. 3 illustrates an exemplary method for transmission using a PUR.

FIG. 4 illustrates an exemplary signal sequence for transmission using a PUR.

FIG. 5 illustrates an exemplary method for transmission using a PUR.

FIG. 6 illustrates an example of retaining the PUR configuration for a period of time.

FIG. 7 illustrates an exemplary method for transmission using a PUR.

FIG. 8 illustrates an example of skipping a release of the PUR configuration for a period of time.

FIG. 9 illustrates an exemplary method for transmission using a PUR.

FIG. 10 illustrates an exemplary method for transmission using a PUR.

FIG. 11 illustrates an exemplary method for transmission using a PUR.

FIG. 12 illustrates an exemplary method for indicating a transmission using a PUR.

FIG. 13 illustrates an exemplary scenario.

FIG. 14 illustrates an example of multiple PUR configurations and multiple

PUR indications.

FIG. 15 illustrates an example apparatus according to an embodiment.

FIG. 16 illustrates an example apparatus according to an embodiment.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3GPP 5G and so on. It is contemplated that along with developments of network architectures and new service scenarios, all embodiments in the present application are also applicable to similar technical problems, and moreover, the terminologies recited in the present application may change, which should not affect the principle of the present application.

The present disclosure relates to a transmission using a PUR in radio accesses technologies. The PUR allows one uplink transmission in RRC_IDLE without performing the random access procedure. As a result, the signaling overhead, UE power consumption, and latency for completing data transmission may be reduced.

A legacy PUR configuration is only valid in the cell where a UE receives the

PUR configuration. Furthermore, the legacy PUR configuration is implicitly released at the UE and the BS when, for examples, the UE accesses in another cell where the PUR is no longer enabled, or the PUR is not used for a configured number of consecutive occasions.

The radio access technologies may be applied to non-terrestrial networks

(NTN), and other radio access networks where a UE and/or a BS may move time to time. The UE may use the PUR as a baseline for small data packet transmissions/receptions to skip a random access and avoid a transition to RRC_CONNECTED.

In such cases when a UE and/or a BS moves time to time, there may be cell changes, and the benefit get from a PUR may meet challenges.

For example, in the scenario of the NTN low Earth orbiting (LEO), the satellites orbit around the Earth. Even if the UE is static on the Earth, it may hand over to another cell covered by a different satellite.

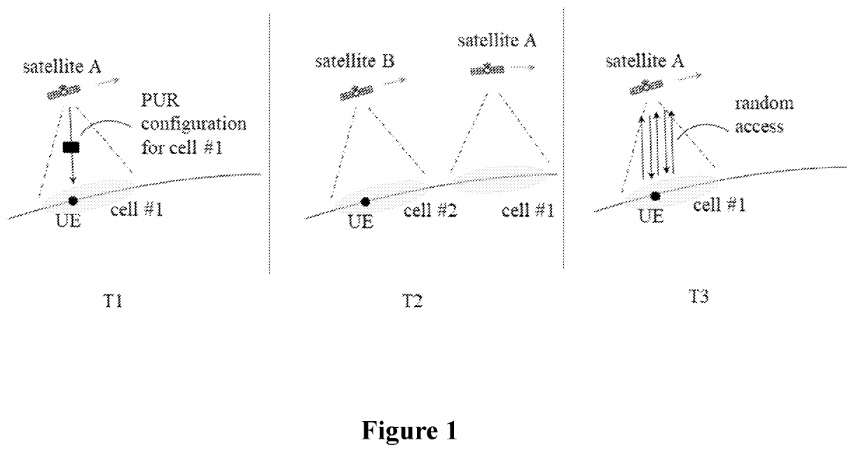

FIG. 1 illustrates an example that a PUR configuration is released due to a cell movement according to the legacy PUR specification.

As shown in FIG. 1, at the time T1, the UE is in the cell #1 coverage provided by the satellite A, the satellite A configures the PUR for the UE, and the PUR configuration is only valid when the UE is in the cell #1 coverage. At the time T2, due to the satellites movement, even if the UE is static, it is in the cell #2 coverage provided by the satellite B, and the PUR configuration for the cell #1 is released. At the time T3, the satellite A moves back to provide the cell #1 coverage for the UE again. However, as the PUR configuration for the cell #1 was released when the UE entered the cell #2 due to the legacy PUR specification, at the time T3, there is no PUR configuration available for the cell #1, the UE has to enter the RRC_CONNECTED to get a PUR configuration for uplink data transmission again, or the UE has to initiate a random access for uplink data transmission without a PUR configuration.

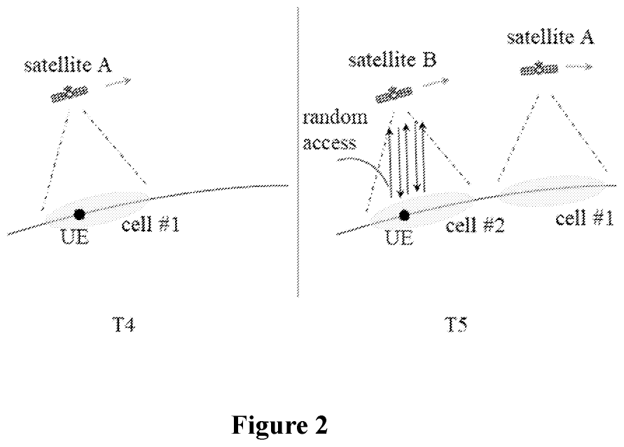

FIG. 2 shows an example that a PUR configuration is limited to the configuring cell according to the legacy PUR specification.

According to the legacy PUR specification, the PUR configuration is limited to the configuring cell. Therefore, the UE at least has to initiate random access once in each cell covered by the satellites to obtain the PUR configuration.

As shown in FIG. 2, at the time T4, the UE is in the cell #1 coverage provided by the satellite A, the satellite A configures the PUR for the UE, and the PUR configuration is only valid when the UE stays in the cell #1 coverage. Due to the legacy PUR specification, the satellite A cannot configure a PUR of the cell #2 for the UE in advance. Therefore, when the UE enters the cell #2 coverage provided by the satellite B due to the satellites movement even if the UE is static, the UE has to perform a random access first at the time T5 before it initiates a data transmission in the cell #2.

It can be seen that, cell changes caused by movements of a UE and/or a BS may result in multiple PUR configuration releases, multiple random access procedures, multiple RRC_CONNECTED setting procedures, and multiple PUR configuration procedures. Therefore, additional signaling overhead, the UE power consumption, and latency for completing data transmission may be increased, it may combat the benefits of the transmission using the PUR.

It is contemplated that the PUR is configured in RRC_CONNECTED, the network knows the TA of the UE and may take it into consideration when configuring the PUR and scheduling a reception window. In another word, an initial TA is used during the random access procedure and a timing advance (TA) refinement is used in RRC_CONNECTED.

It is contemplated that, in a scenario that a UE and/or a BS move time to time, the propagation delay between the UE and the BS varies. Although there is a parameter pur-TimeAlignmentTimer configured for usage, the UE still need to maintain an accurate TA so that the network may identify the PUR used by the UE and receive data at right time.

Furthermore, the legacy PUR assumes a small propagation delay; therefore, the PUR response window starts at the subframe that contains the end of the corresponding Physical Uplink Shared Channel (PUSCH) transmission, plus 4 subframes (4 ms), and has the length pur-ResponseWindowSize which may be larger than the maximum round-trip propagation delay in the cell to ensure the reception. However, it is unnecessary to configure such a large PUR response window to cover the propagation delay when, for example, the UE is far away from the BS (e.g., a satellite). An enhancement for appropriate PUR window configuration may be useful e.g., to at least skip monitoring in the inevitable propagation delay for less power consumption.

Herein below, some example embodiments are described in detail with reference to the accompanying drawings according to the present disclosure. The following description includes specific details for the purpose of providing a thorough understanding of various concepts. However, it will be apparent to those skilled in the art that these concepts may be practiced without these specific details.

Considering that there are various conditions or scenarios for using a PUR, the present disclosure introduces varies PUR application conditions or various PUR indications for the usage of the PUR. Furthermore, these various PUR application conditions or various PUR indications may be combined together according to a real environment. The advantages are, for examples, to use the PUR in a wider range of scenarios, to give full play to the advantages of the PUR, and to eliminate the unfavorable factors that affect the use of the PUR.

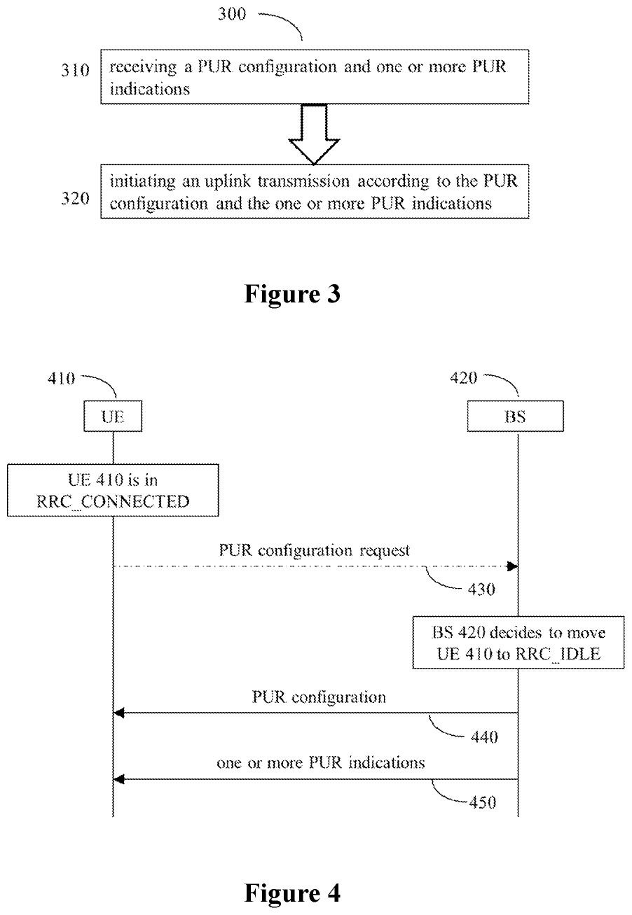

FIG. 3 illustrates an exemplary method 300 performed by a UE to transmitting data using a PUR according to the present disclosure.

As shown in FIG. 3, the method 300 may include a step 310 of receiving a PUR configuration and one or more PUR indications from a BS, and a step 320 of initiating an uplink transmission to the BS according to the PUR configuration and the one or more PUR indications.

In some embodiments of the present application, the BS may be referred to as an access point, an access terminal, a base, a base unit, a macro cell, a Node-B, an evolved Node B (eNB), a generalized NodeB (gNB), a Home Node-B, a relay node, or a device, or described using other terminology used in the art.

More details of the example method 300 are described below.

In step 310, the UE may receive one or more PUR indications corresponding to one or more PUR application conditions. In various embodiments, each of the PUR indications indicates a PUR application condition of the PUR configuration. The PUR application condition may be, for examples, for retaining the PUR configuration for a period of time, for skipping a release of the PUR configuration for a period of time, for applying the PUR configuration in an area, for maintaining a TA for the PUR, or for postponing the response window of the PUR.

In some embodiments, there is no strict order for receiving the one or more PUR indications and the PUR configuration. The one or more PUR indications may be received earlier or later than the reception of the PUR configuration, or received at the same time when the PUR configuration is received. Furthermore, the order in which the one or more PUR indications are received may be not strictly specified.

FIG. 4 illustrates an exemplary signal sequence according to the exemplary method 300.

As shown in FIG. 4, at first, the UE 410 is in RRC_CONNECTED. When certain conditions are met, the BS 420 decides to move the UE 410 to RRC_IDLE, and a signaling RRCConnectionRelease is sent to the UE 410. Furthermore, since the cell enables the PUR and the UE supports the PUR, a PUR configuration 440 is also sent to the UE 410.

The PUR configuration 440 may be included in the signaling (e.g., RRCConnectionRelease). The one or more PUR indications 450 are associated with the PUR configuration 440.

The PUR configuration request 430 is optional. In certain networks, the PUR configuration 440 is sent based on the PUR configuration request 430. In certain networks, the PUR configuration 440 is sent no matter whether the UE 410 sends the PUR configuration request 430.

In some embodiments, the one or more PUR indications 450 are included in a radio resource control (RRC) signaling or are broadcasted in a system information block (SIB).

In some embodiments, the one or more PUR indications 450 are included in an RRC connection release command along with the PUR configuration.

In some embodiments, one PUR application condition is for retaining the PUR configuration for a period of time, i.e., the corresponding PUR indication 450 indicates that a UE retains the PUR configuration 440 during the period of time.

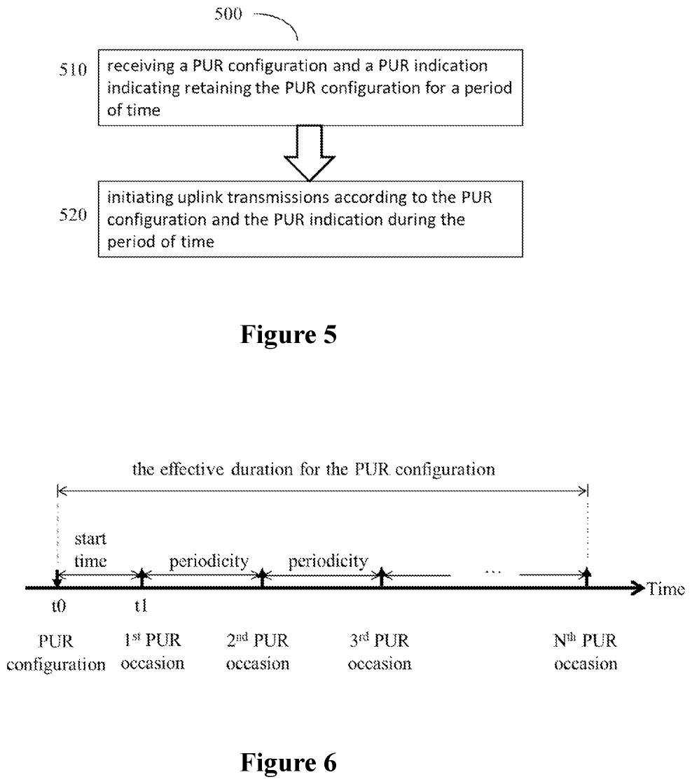

FIG. 5 illustrates an exemplary method 500 of the method 300.

As shown in FIG. 5, the method 500 may include a step 510 of receiving, from a BS (e.g., the BS 420), a PUR configuration 440 and a PUR indication 450 indicating retaining the PUR configuration 440 for a period of time, and a step 520 of initiating uplink transmissions according to the PUR configuration 440 and the PUR indication 450 during the period of time.

In some embodiments, the period of time specified in the step 510 starts at the time when the PUR configuration is received or when the UE (e.g., the UE 410) enters the cell or the area where the PUR configuration is effective.

During this period of time, the UE may perform a transmission using the PUR. After the end of this period, the UE may still retain the PUR configuration till a release condition is met.

For example, according to the method 500, the UE receives a PUR configuration and a PUR indication in a cell or a radio network, and the PUR indication indicates retaining the PUR configuration for a period of time. If the UE moves out the cell or the radio network and moves back to the cell or the radio network within this period of time, the UE may still retain the PUR configuration and may perform an uplink transmission using the PUR directly without initiating a random access procedure.

Referring to FIG. 1 again, according to the method 500 of the present disclosure, if T3 is within the period of time, then the UE may perform a transmission using the PUR directly without initiating a random access procedure.

In some embodiments, the period of time specified in the step 510 includes N consecutive PUR occasions, and wherein N is a positive integer.

In some embodiments, the N is indicated by the PUR indication, configured by the UE (e.g., the UE 410), or preconfigured.

FIG. 6 illustrates an example of retaining a PUR configuration (e.g., the PUR configuration 440) for a period of time which includes N consecutive PUR occasions corresponding to the method 500. An occasion refers to a radio resource in time and/or frequency domain. A PUR occasion refers to a radio resource in time domain at a given frequency band that is preconfigured to a UE (e.g., the UE 410) for uplink transmission.

As shown in FIG. 6, at time t0, the UE (e.g., the UE 410) receives a PUR configuration (e.g., the PUR configuration 440). Furthermore, the UE receives a PUR indication (e.g., the one or more PUR indication 450) associated with the PUR configuration earlier or later or at the same time. The PUR indication indicates retaining the PUR configuration within the period of time which includes N consecutive PUR occasions. It means that, during the time t0˜(t0+start time+(N−1)*periodicity), the UE still retains the PUR configuration. The start time is the time interval from the time t0 that the UE receives the PUR configuration to the time t1 that the first PUR occasion happens.

In some embodiments, the PUR indication indicates retaining the PUR configuration for the period of time specified in step 510. The UE starts a retaining timer upon receiving a PUR configuration or upon entering the cell where the PUR configuration is effective, and retains the PUR configuration at least till the expiration of the retaining timer. After the expiration of the retaining time, the PUR configuration may be released if a release condition is met.

In some embodiments, one PUR application condition is for skipping a release of the PUR configuration for a period of time, i.e., the corresponding PUR indication 450 indicates that the UE skips the release of the PUR configuration during the period of time.

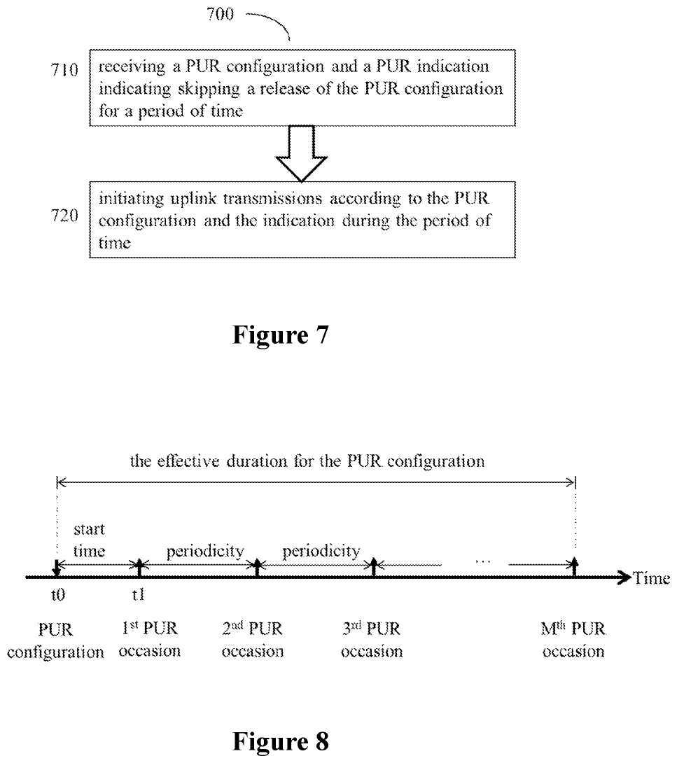

FIG. 7 illustrates an exemplary method 700 according to the method 300.

As shown in FIG. 7, the method 700 may include a step 710 of receiving, from a BS (e.g., the BS 420), a PUR configuration 440 and a PUR indication 450 indicating skipping a release of the PUR configuration 440 for a period of time, and a step 720 of initiating uplink transmissions according to the PUR configuration 440 and the PUR indication 450 during the period of time.

In some embodiments, the period of time specified in the step 710 starts at the time when the PUR configuration is received or when the UE (e.g., the UE 410) enters the cell or the area where the PUR configuration is effective.

During this period of time, the UE may perform a transmission using the PUR. After the end of this period, the UE may still retain the PUR configuration till a release condition is met.

For example, according to the method 700, the UE receives a PUR configuration and a PUR indication in a cell or a radio network, and the PUR indication indicates skipping a release of the PUR configuration for a period of time. If the UE moves out the cell or the radio network and moves back to the cell or the radio network within this period of time, the UE may skip a release of the PUR configuration due to cell changes and may perform an uplink transmission using the PUR directly without initiating a random access procedure.

Referring to FIG. 1 again, according to the method 700 of the present disclosure, if T3 is within the period of time, when the UE moves to the cell #2, the PUR configuration effective for the cell #1 is not released, and when the UE moves back to the cell #1 within the period of time, the UE may perform a transmission using the PUR directly without initiating a random access procedure.

In some embodiments, the period of time specified in step 710 includes M consecutive PUR occasions, and wherein M is a positive integer.

In some embodiments, the M is indicated by the PUR indication, configured by the UE (e.g., the UE 410), or preconfigured.

FIG. 8 illustrates an example of skipping a release of the PUR configuration (e.g., the PUR configuration 440) for a duration which includes M consecutive PUR occasions corresponding to the method 700.

As shown in FIG. 8, at time t0, the UE (e.g., the UE 410) receives a PUR configuration (e.g., the PUR configuration 440). Furthermore, the UE receives a PUR indication (e.g., the one or more PUR indication 450) associated with the PUR configuration earlier or later or at the same time. The PUR indication indicates skipping a release of the PUR configuration within the duration which includes M consecutive PUR occasions. It means that, during the time t0˜(t0+start time+(M−1)*periodicity), the PUR configuration is stored by the UE and is not released. The start time is the time interval from the time that the UE receives the PUR configuration to the time that the first PUR occasion happens.

In some embodiments, the PUR indication indicates skipping the release of the PUR configuration for the period of time specified in step 710. The UE starts a skipping timer upon receiving a PUR configuration or upon entering the cell where the PUR configuration is effective, and retains the PUR configuration at least till the end of the period of time even if a legacy release condition of the PUR configuration is met. After the skipping timer expires, the PUR configuration may be released if a release condition is met.

Generally, a legacy PUR configuration may be implicitly released at the UE and the BS, when, for examples, the UE accesses a new cell where the PUR is no longer enabled, or the UE performs an RACH initiation in a new cell, or when the PUR resource has not been used for a configured number (e.g., pur-ImplicitReleaseAfter-r16) of consecutive occasions.

However, according to the method 500 or 700, the UE retains or keeps the PUR configuration for a period of time, even if the condition of releasing the PUR configuration is met. During the period of time, the UE does not need to repeatedly release the PUR configuration and/or wait for a PUR configuration for the same cell. Therefore, the signaling overhead, the UE power consumption and the latency for completing data transmission may be reduced.

In some embodiments, one PUR application condition is for applying the PUR configuration (e.g., the PUR configuration 440) in an area, i.e., the PUR indication (e.g., the PUR indication 450) received in the step 310 indicates an area where the PUR configuration is effective.

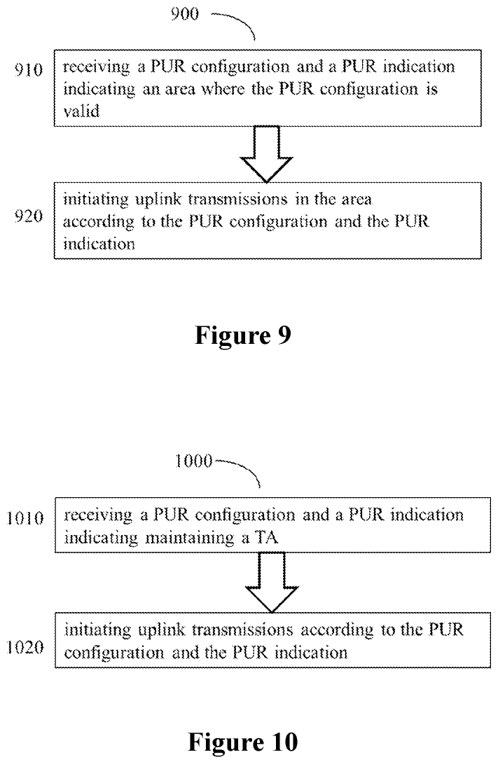

FIG. 9 illustrates an exemplary method 900 according to the method 300.

As shown in FIG. 9, the method 900 may include a step 910 of receiving, from a BS (e.g., the BS 420), a PUR configuration (e.g., the PUR configuration 440) and a PUR indication (e.g., the one or more PUR indication 450) indicating an area where the PUR configuration is valid, and a step 920 of initiating uplink transmissions in the area according to the PUR configuration and the PUR indication.

In some embodiments, the location where the UE 410 receives the PUR configuration and the PUR indication is not included in the area.

In some embodiments, the area may include one or more cells and/or one or more radio networks.

In some embodiments, the area may be larger or smaller than a cell or a radio network.

In some embodiments, the area may be a cell or a radio network.

In some embodiments, the PUR indication may include one or more cell identifications (IDs) and/or one or more PUR-radio network temporary identities (RNTIs).

In some embodiments, when the UE receives the PUR configuration and/or the PUR indication, it may or may not be in the area.

Furthermore, in some embodiments, the UE may receive multiple PUR configurations and multiple PUR indications. Each PUR indication is associated with a PUR configuration of the multiple PUR configurations, and indicates an area where the associated PUR configuration is effective. Moreover, the areas indicated by the multiple PUR indications may or may not border one another.

In some embodiments, the UE may be in one or none of the multiple areas when the UE receives the multiple PUR configurations and/or multiple PUR indications.

For example, the UE receives two PUR configurations and two PUR indications, wherein, one PUR indication indicates that one PUR configuration is effective in one area, the other PUR indication indicates that the other PUR configuration is effective in the other area. The two areas may or may not border each other. The UE may be in one or none of the two areas when it receives the two PUR configurations and/or the two PUR indications.

Due to legacy PUR specification, a PUR configuration is only valid where the UE receives the PUR configuration. For example, referring to FIG. 2, when the UE stays in the cell #1, the satellite A (i.e., the BS of the cell #1) cannot send a PUR configuration for cell #2 to the UE. If the satellite A sends a PUR configuration to the UE, the PUR configuration is merely effective for cell #1. Therefore, when the UE moves to the cell #2 due to the movement of the UE and/or the satellite A, the UE has to initiate a random access once to obtain a PUR configuration effective for cell #2.

According to the method 900 of the present disclosure, when the UE stays in the cell #1, the BS #1 may send a PUR configuration and a PUR indication to the UE, wherein the PUR indication indicates that the PUR configuration is effective in both the cell #1 and the cell #2 (i.e., the area includes the cell #1 and the cell #2), or effective in the cell #1, or effective in the cell #2, or effective in other area that may or may not include the cell #1 and/or the cell #2.

If the PUR indication indicates that the PUR configuration is effective in an area including both the cell#1 and cell #2, when the UE moves to the cell #2 due to the movements of the UE and/or the satellite (or the BS), the UE does not need to initiate a random access to get a PUR configuration first, it may initiate transmissions using the PUR directly. According some embodiments, the UE may receive a PUR for cell #1 and a PUR for cell#2. When the UE initiating the uplink transmission in cell #1, the PUR for cell #1 is activated. When the UE initiating the uplink transmission in cell #2, the PUR for cell #2 is activated. As a result, the random access procedures for initiating uplink transmission with each satellite (or BS) can omitted. Therefore, the signaling overhead, the UE power consumption and the latency for completing data transmission may be reduced.

In some embodiments, the PUR application condition is for maintaining a TA between the UE (e.g., the UE 410) and a BS (e.g., the BS 420), i.e., the PUR indication (e.g., the PUR indication 450) indicates that the UE maintains the TA by the UE.

When the UE is in RRC_CONNECTED, the BS knows the TA, an initial TA and a TA refinement are used for the PUR configuration (e.g., the PUR configuration 440). However, if the UE is in RRC_IDLE, the BS does not know the TA and may not correctly identify the PUR used by the UE and/or receive data at right time.

Therefore, in a scenario (e.g., the scenario NTN LEO, or the UE remaining among multiple cells) that a UE and/or a BS moves time to time, the propagation delay between the UE and the BS varies.

In such a scenario that the TA between the UE and the BS varies time to time, if the UE performs a transmission using the PUR in RRC_IDLE, the UE need to maintain or determine an accurate TA so that the BS may identify the PUR used by the UE and receive data at right time, even if there is a parameter pur-TimeAlignmentTimer configured for usage,

FIG. 10 illustrates an exemplary method 1000 according to the method 300.

As shown in FIG. 10, the method 1000 may include a step 1010 of receiving, from a BS (e.g., the BS 420), a PUR configuration (e.g., the PUR configuration 440) and a PUR indication (e.g., the one or more PUR indication 450) indicating maintaining a TA, and a step 1020 of initiating uplink transmissions according to the PUR configuration and the PUR indication.

In some embodiments, the UE receives a PUR configuration and a PUR indication in a cell or a radio network, and the PUR indication indicates maintaining a TA. It means that the UE maintains the TA when the UE is in the cell or the radio network and the PUR configuration is effective.

In some embodiments, the UE (e.g., the UE 410) estimates a propagation delay between the UE and the BS (e.g., the BS 420) according to the locations of the UE and the BS, and determines the TA according to the estimated propagation delay.

For example, in a scenario of the NTN, the UE knows the locations of the serving BS (e.g., a serving satellite) through the satellite ephemeris. The UE may estimates the propagation delay according to the locations of the UE itself and the serving satellite.

In some embodiments, the PUR indication further indicates that the UE logs or stores a current TA or propagation delay. The UE logs or stores the current TA or propagation delay of the current PUR occasion, estimates a propagation delay between the UE and the BS for the next PUR occasion, and determines the TA for the next PUR occasion according to the logged or stored current TA or propagation delay and the estimated propagation delay.

In some embodiments, the UE compensates the TA with [the estimated propagation delay—the logged or stored current TA or propagation delay] when initiating the next PUR occasion.

In some embodiments, the PUR indication further includes a current TA or propagation delay. The UE estimates a propagation delay between the UE and the BS, and determines the TA according to the current TA or propagation delay included in the PUR indication and the estimated propagation delay.

In some embodiments, the UE compensates the TA with [the estimated propagation delay—the current TA or propagation delay included in the PUR indication] when initiating the next PUR occasion.

According to the method 1000 of the present disclosure, the UE may maintain an accurate TA so that the BS may identify the PUR used by the UE and receive data at right time, even if the UE moves in the serving cell due to the movements of the UR and/or the BS.

In some embodiments, one PUR application condition is for postponing a PUR response window of the UE (e.g., the UE 410) for a period of time, i.e., the PUR indication (e.g., the PUR indication 450) indicates that the UE postpones the PUR response window of the UE for the period of time.

According to the PUR specification, after a transmission using the PUR initiated by the UE, the Medium Access Control (MAC) entity uses a timer pur-ResponseWindowTimer to monitor the Physical Download Control Channel (PDCCH) identified by PUR-RNTI in the PUR response window. The PUR response window starts at the subframe that contains the end of the corresponding Physical Uplink Shared Channel (PUSCH) transmission, plus 4 subframes (4 ms), and has the length pur-ResponseWindowSize.

Despite of that the round-trip propagation delay of NTN (12.89 ms˜541.46 ms) may be included in the configurable range of PUR response window, it is unnecessary to configure such a large PUR response window to cover such delay. This is because that no data reception is possible at least in the period of minimum propagation delay in the cell.

In some scenarios, the minimum propagation delay in the cell may not be ignored. For example, in the scenario of NTN, the distance between the base station (i.e., the satellite) and the UE is large, even the minimum propagation delay is not small. Therefore, it may need to consider postponing the PUR response window for a period of time.

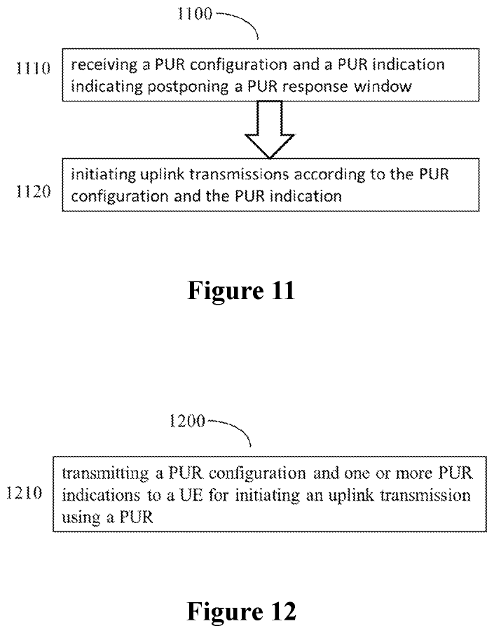

FIG. 11 illustrates an exemplary method 1100 according to the method 300.

As shown in FIG. 11, the method 1100 may include a step 1110 of receiving, from a BS (e.g., the BS 420), a PUR configuration (e.g., the PUR configuration 440) and a PUR indication (e.g., the one or more PUR indication 450) indicating postponing a PUR response window for a period of time, and a step 1120 of initiating uplink transmissions according to the PUR configuration and the PUR indication.

In some embodiments, the UE receives a PUR configuration and a PUR indication in a cell or a radio network, and the PUR indication indicates postponing the PUR response window for a period of time. It means that the UE postpones the PUR response window for the period of time when the UE is in the cell or the radio network and the PUR configuration is effective.

In some embodiments, the period of time may be a TA estimated by the UE according to the locations of the UE and the BS.

In some embodiments, the period of time may be a common TA in the serving cell. The common TA is associated with the smallest distance between the UE and the BS. For example, in the scenario of NTN, the common TA is the smallest distance between the satellite and the Earth.

In some embodiments, the common TA may be included in the PUR indication, or known by the UE. For example, in the scenario of NTN, the UE may know the common TA through a satellite ephemeris

According to the method 1100, the UE may skip monitoring in the inevitable propagation delay; therefore the power consumption may be decreased.

FIG. 12 illustrates an exemplary method 1200 performed by a BS (e.g., the

BS 420) according to the present disclosure. The method 1200 corresponds to the method 300 performed by a UE (e.g., the UE 410).

As shown in FIG. 12, the method 1200 may include a step 1210 of transmitting, to a UE (e.g., the UE 410), a PUR configuration (e.g., PUR configuration 440) and one or more PUR indications (e.g., the one or more PUR indications 450), for the UE initiating an uplink transmission using a PUR.

In some embodiments of the present application, the BS may be referred to as an access point, an access terminal, a base, a base unit, a macro cell, a Node-B, an eNB, a gNB, a Home Node-B, a relay node, or a device, or described using other terminology used in the art.

In various embodiments, each of the one or more PUR indications indicates an application condition of the PUR configuration. The application condition may be, for examples, for retaining the PUR configuration for a period of time, for skipping a release of the PUR configuration for a period of time, for applying the PUR configuration in an area, for maintaining the TA for the PUR, or for postponing the PUR response window.

In some embodiments, the one or more PUR indications may be transmitted earlier or later than the transmission of the PUR configuration, or transmitted at the same time when the PUR configuration is transmitted.

In some embodiments, the one or more PUR indications are included in an RRC signaling or are broadcasted in a SIB.

In some embodiments, the one or more PUR indications are included in an RRC connection release command along with the PUR configuration.

In some embodiments, one PUR indication indicates that the UE retains the PUR configuration for a period of time.

In some embodiments, the period of time starts at the time when the PUR configuration is received or when the UE enters the cell or the area where the PUR configuration is effective.

During this period of time, the UE may perform a transmission using the PUR. After the end of this period, the UE may still retain the PUR configuration till a release condition is met.

In some embodiments, the period of time includes N consecutive PUR occasions, and wherein the N is a positive integer.

In some embodiments, the PUR indication indicates that the UE starts a retaining timer for the period of time, and applies the PUR configuration till the retaining timer expires.

In some embodiments, one PUR indication indicates that the UE skips a release of the PUR configuration for a period of time.

In some embodiments, the period of time starts at the time when the PUR configuration is received or when the UE enters the cell or the area where the PUR configuration is effective.

During this period of time, the UE may perform a transmission using the PUR. After the end of this period, the UE may still retain the PUR configuration till a release condition is met.

In some embodiments, the period of time includes M consecutive PUR occasions, and wherein the M is a positive integer.

In some embodiments, the PUR indication indicates that the UE starts a skipping timer for the period of time, and skips releases of the PUR configuration till the skipping timer expires.

In some embodiments, the PUR indication indicates that the UE may apply the PUR configuration in an area, even if the UE is not in the area when it receives the PUR indication and/or the PUR configuration.

When the UE (e.g., the UE 410) enters into the area, the UE may initiate a transmission according to the PUR configuration and the PUR indication.

In some embodiments, the area may include one or more cells and/or one or more radio networks

In some embodiments, the area may be larger or smaller than a cell or a radio network.

In some embodiments, the area may be a cell or a radio network.

In some embodiments, the PUR indication may include one or more cell identifications (IDs) and/or one or more PUR-radio network temporary identities (RNTIs).

In some embodiments, when the BS transmits the PUR configuration and/or the PUR indication, the UE may or may not be in the area.

Furthermore, in some embodiments, the BS may transmit multiple PUR configurations and multiple PUR indications. Each PUR indication is associated with a PUR configuration of the multiple PUR configurations, and indicates an area where the associated PUR configuration is effective. Moreover, the areas indicated by the multiple PUR indications may or may not border one another.

In some embodiments, the UE may be in one or none of the multiple areas when the UE receives the multiple PUR configurations and/or multiple PUR indications.

In some embodiments, the PUR indication (e.g., the PUR indication 450) indicates that the UE maintains a TA between the BS and the UE.

In some embodiments, the PUR indication indicates that the UE (e.g., the UE 410) estimates a propagation delay between the UE and the BS (e.g., the BS 420) according to the locations of the UE and the BS, and determines the TA according to the estimated propagation delay.

In some embodiments, the PUR indication further indicates the UE logs or stores a current TA or propagation delay. According to the PUR indication, the UE logs or stores the current TA or propagation delay of the current PUR occasion, estimates a propagation delay between the UE and the BS in the next PUR occasion, and determines the TA for the next PUR occasion according to the logged or stored current TA or propagation delay and the estimated propagation delay.

In some embodiments, the UE compensates the TA with [the estimated propagation delay—the logged or stored current TA or propagation delay] when initiating the next PUR occasion.

In some embodiments, the PUR indication further includes a current TA or propagation delay. According to the PUR indication, the UE estimates a propagation delay between the UE and the BS, and determines the TA according to the current TA or propagation delay included in the PUR indication and the estimated propagation delay.

In some embodiments, the UE compensates the TA with [the estimated propagation delay—the logged or stored current TA or propagation delay] when initiating the next PUR occasion.

In some embodiments, the PUR indication indicates that the UE postpones the PUR response window for a period of time.

In some embodiments, the period of time may be a TA estimated by the UE according to the locations of the UE and the BS.

In some embodiments, the period of time may be a common TA in the serving cell. The common TA is associated with the smallest distance between the UE and the BS. For example, in the scenario of NTN, the common TA is the smallest distance between the satellite and the Earth.

In some embodiments, the common TA may be included in the PUR indication, or known by the UE. For example, in the scenario of NTN, the UE may know the common TA through a satellite ephemeris

On the basis of not violating the inventive spirit of the present invention, the above various embodiments in the present invention can be reasonably combined and reasonably extended.

For example, if the UE 410 is in the cell #1, it receives a PUR configuration and two PUR indications. One PUR indication indicates that the PUR configuration is valid when the UE 410 enters the cell #2, and the other PUR indication indicates that the UE 410 maintains the PUR configuration for a period of time (e.g., N consecutive PUR occasions) since the UE 410 enters the cell #2.

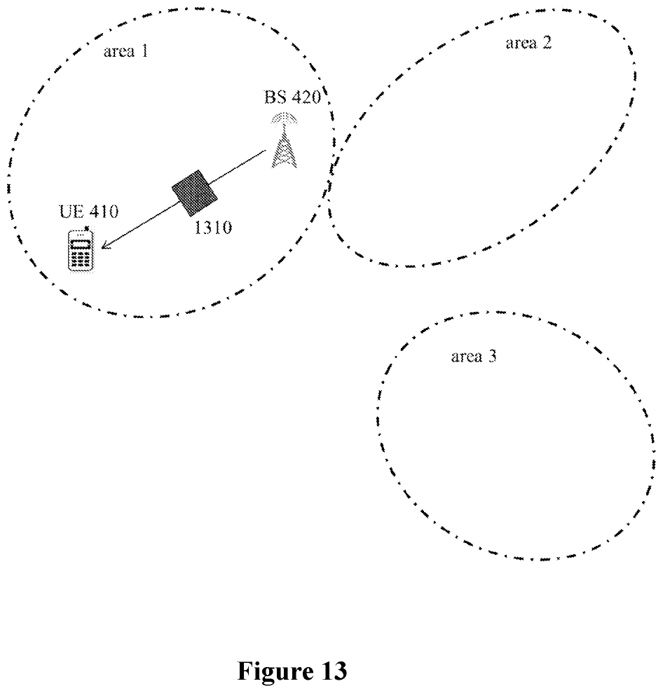

For another example, referring to a scenario shown in FIG. 13, the UE 410 is in the area 1, the area 1 and the area 2 border with each other, and neither of them borders with the area 3.

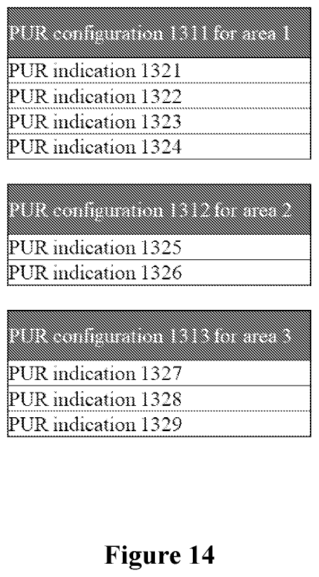

The BS 420 sends information 1310 to the UE 410, wherein the information 1310 includes multiple PUR configurations and multiple PUR indications as shown in FIG. 14.

As shown in FIG. 14, the UE 410 is in the area 1, and the BS 420 sends three PUR configurations 1311, 1312, and 1313 to the UE 410.

The PUR indications 1321, 1322, 1323, and 1324 are associated with the PUR configuration 1311.

For example, the PUR indication 1321 indicates that the PUR configuration 1311 is effective in the area 1 for transmission using the PUR.

For example, the PUR indication 1322 indicates that the UE 410 retains the PUR configuration 1311 for a period of time (e.g., including N consecutive PUR occasions) since the UE receives the PUR configuration 1311 in the area 1.

For example, the PUR indication 1323 indicates that the UE 410 maintains the TA between the UE 410 and the BS 420 when the UE 410 is in the area 1.

For example, the PUR indication 1324 indicates that the UE 410 postpone the PUR response window for a period of time (e.g., a TA) when the UE 410 is in the area 1.

The PUR indications 1325 and 1326 are associated with the PUR configuration 1312.

For example, the PUR indication 1325 indicates that the PUR configuration 1312 is valid in the area 2 for transmission using the PUR.

For example, the PUR indication 1326 indicates that the UE 410 skips releases of the PUR configuration 1312 for a period of time (e.g., including M consecutive PUR occasions) since the UE enters the area 2.

The PUR indications 1327, 1328, and 1329 are associated with the PUR configuration 1313.

For example, the PUR indication 1327 indicates that the PUR configuration 1313 is valid in the area 3 for transmission using the PUR.

For example, the PUR indication 1327 indicates that the UE 410 skips releases of the PUR configuration 1313 for a period of time (e.g., including M consecutive PUR occasions) since the UE enters the area 3.

For example, the PUR indication 1328 indicates that the UE 410 maintains the TA between the UE 410 and the BS in the area 3 when the UE 410 is in the area 3.

For example, the PUR indication 1329 indicates that the UE 410 postpones the PUR response window for a period of time (e.g., a TA) when the UE 410 is in the area 3.

In some embodiments, there is no strict transmission order for the PUR configurations and the PUR indications shown in FIG. 14.

In some embodiments, the UE 410 may receive more or less PUR configurations and PUR indications.

In some embodiments, more or less areas are involved.

In some embodiments, each of the areas 1, 2, or 3 may be a cell, a radio network, or multiple cells or multiple radio networks, or a combination of at least one cell and at least one radio network.

In some embodiments, the PUR indications and the PUR configurations may be not exactly the same as shown in FIG. 14.

According to the embodiment shown in FIG. 13 in combination with FIG. 14, it can be seen that, during one random access procedure initiated in the area 1, the PUR configurations and the PUR indications for three areas are received; therefore, the UE does not initiate other random access procedures in areas 2 and 3 to get corresponding PUR configurations.

Furthermore, as the areas 1, 2, or 3 may include multiple cells or multiple radio networks, the UE does not need to initiate a random access procedure and wait for a PUR configuration for each cell or each radio network.

Moreover, some PUR configuration may be retained for a period of time or some PUR releases may be skipped in a period of time, so that during the period of time, the UE does not need to repeatedly release the PUR configuration and/or wait for a PUR configuration in the same area.

In addition, in some areas, the PUR response window is postponed. Therefore, the time for monitoring the PDCCH is reduced.

Besides, in some areas the UE maintains the TA between the UE and the serving BS. Therefore, the network may identify the PUR used by the UE and receive data at right time, the performance of the whole system may be improved.

In view of all, according to the embodiment shown in FIG. 13 in combination with FIG. 14, additional signaling overhead, the UE power consumption, latency for completing data transmission may be decreased, and the performance of the whole system may be improved. These advantages may be more obvious in a scenario that the UE or the BS moves time to time.

The embodiment shown in FIG. 13 in combination with 14 is merely an example. Actually, there may be various combinations of the aforementioned embodiments and various reasonable extensions of the aforementioned embodiments based on the spirit of the present disclosure.

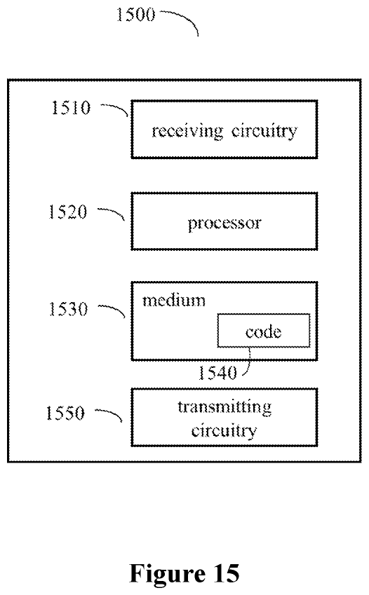

FIG. 15 illustrates an example apparatus 1500 for initiating transmission using a PUR in an embodiment, which, for example, may be at least a part of a UE (e.g. the UE 410).

As shown in FIG. 15, the apparatus 1500 may include at least one receiving circuitry 1510, at least one processor 1520, at least one non-transitory computer-readable medium 1530 with computer-executable 1540 stored thereon, and at least one transmitting circuitry 1550. The at least one medium 1530 and the computer program code 1540 may be configured to, with the at least one processor 1520, cause the apparatus 1500 at least to perform at least the example method 300 described above, wherein, for example, the apparatus 1500 may be the UE in the example method 300.

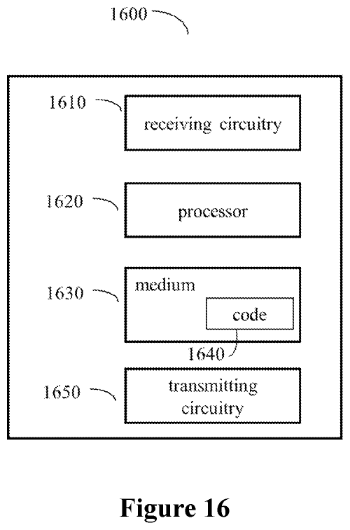

FIG. 16 illustrates an example apparatus 1600 for indicating a UE to initiate transmission using a PUR in an embodiment, which, for example, may be at least a part of a BS (e.g. the BS 420).

As shown in FIG. 16, the apparatus 1600 may include at least one receiving circuitry 1610, at least one processor 1620, at least one non-transitory computer-readable medium 1630 with computer-executable 1640 stored thereon, and at least one transmitting circuitry 1650. The at least one medium 1630 and the computer program code 1640 may be configured to, with the at least one processor 1620, cause the apparatus 1600 at least to perform at least the example method 1200 described above, wherein, for example, the apparatus 1600 may be the BS in the example method 1200.

In various example embodiments, the at least one processor 1520 or 1620 may include, but not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the at least one processor 1520 or 1620 may also include at least one other circuitry or element not shown in FIG. 15 or 16.

In various example embodiments, the at least one medium 1530 or 1630 may include at least one storage medium in various forms, such as a volatile memory and/or a non-volatile memory. The volatile memory may include, but not limited to, for example, an RAM, a cache, and so on. The non-volatile memory may include, but not limited to, for example, an ROM, a hard disk, a flash memory, and so on. Further, the at least medium 1530 or 1630 may include, but are not limited to, an electric, a magnetic, an optical, an electromagnetic, an infrared, or a semiconductor system, apparatus, or device or any combination of the above.

Further, in various example embodiments, the example apparatus 1500 or 1600 may also include at least one other circuitry, element, and interface, for example antenna element, and the like.

In various example embodiments, the circuitries, parts, elements, and interfaces in the example apparatus 1500 or 1600, including the at least one processor 1520 or 1620 and the at least one medium 1530 or 1630, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1-42. (canceled)

43. User equipment (UE), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry;
wherein the computer-executable instructions cause the processor to implement a method, the method comprising:
receiving a first preconfigured uplink resource (PUR) configuration and one or more PUR indications; and
initiating an uplink transmission according to the first PUR configuration and the one or more PUR indications.

44. The UE of claim 43, wherein the one or more PUR indications comprise a first PUR indication indicating retaining the PUR configuration for a first period of time.

45. The UE of claim 44, further comprising:
retaining the PUR configuration for the first period of time,
wherein the first period of time includes N consecutive PUR occasions, and wherein the N is a positive integer.

46. The UE of claim 43, wherein the one or more PUR indications comprise a second PUR indication indicating skipping a release of the PUR configuration for a third period of time.

47. The UE of claim 43, wherein the one or more PUR indications comprise a third PUR indication, associated with the first PUR configuration, indicating a first area in which the first PUR configuration is valid.

48. The UE of claim 43, wherein the one or more PUR indications comprise a fifth PUR indication indicating maintaining a timing advance (TA) for the uplink transmission between the UE and a base station (BS).

49. The UE of claim 43, wherein the one or more PUR indications comprise a sixth PUR indication indicating postponing a response window for the uplink transmission for a fifth period of time.

50. The UE of claim 49, wherein the fifth period of time is determined according to a TA for uplink transmission.

51. The UE of claim 43, wherein the one or more PUR indication is included in a radio resource control (RRC) signaling or is broadcasted in a system information block (SIB).

52. The UE of claim 43, wherein the one or more PUR indication is included in an RRC connection release command along with the first PUR configuration.

53. A base station (BS), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry;
wherein the computer-executable instructions cause the processor to implement a method, the method comprising:
transmitting, to a user equipment (UE), a first preconfigured uplink resource (PUR) configuration and one or more PUR indications, for an uplink transmission initiated by the UE.

54. The BS of claim 53, wherein the one or more PUR indications comprise a first PUR indication indicating retaining the PUR configuration for a first period of time.

55. The BS of claim 54, wherein the PUR configuration is retained by the UE for the first period of time, and the first period of time includes N consecutive PUR occasions, and wherein the N is a positive integer.

56. The BS of claim 54, wherein the first PUR indication is associated with a retaining timer and the PUR configuration is valid for the UE till the retaining timer expires.

57. The BS of claim 53, wherein the one or more PUR indications comprise a second PUR indication indicating skipping a release of the PUR configuration for a third period of time.

58. The BS of claim 53, wherein the one or more PUR indications comprise a third PUR indication, associated with the first PUR configuration, indicating a first area in which the first PUR configuration is valid.

59. The BS of claim 53, wherein the one or more PUR indications comprise a fifth PUR indication indicating maintaining a timing advance (TA) for the uplink transmission between the UE and a base station (BS).

60. The BS of claim 53, wherein the one or more PUR indications comprise a sixth PUR indication indicating postponing a response window for the uplink transmission for a fifth period of time.

61. The BS of claim 60, wherein the fifth period of time is determined according to a TA for uplink transmission.

62. A method performed by user equipment (UE), the method comprising:
receiving a first preconfigured uplink resource (PUR) configuration and one or more PUR indications; and
initiating an uplink transmission according to the first PUR configuration and the one or more PUR indications.
